(19) United States
(12) Patent Application Publication
(10) Pub. No.: US 2022/0205821 A1
(43) Pub. Date: Jun. 30, 2022

(54) UNIFIED SYSTEM FOR PRESSURE AND FLOWRATE MEASUREMENT

(71) Applicant: Itron Golbal SARL, Liberty Lake, WA (US)

(72) Inventors: Stephane Vago, Pont de L Isere (FR); Herve Dury, CHARNAY LES MACON (FR)

(73) Assignee: Itron Golbal SARL

(21) Appl. No.: 17/138,617

(22) Filed: Dec. 30, 2020

(51) Int. Cl. G01F 1/36; G01F 1/40; G01F 1/37

(52) U.S. Cl. CPC G01F 1/363; G01F 1/372; G01F 1/40

(57) ABSTRACT

Techniques to provide a unified system for fluid pressure and fluid flowrate measurement are described. Upstream and downstream transducers include piezo devices, and are in contact with a fluid flow, such as in a pipe within a metering device. In an example, a first signal is sent from the upstream transducer to a downstream transducer, and time-of-flight of the first signal is measured. A second signal is sent from the downstream transducer to the upstream transducer, and a time-of-flight of the second signal is measured. A flowrate of the fluid flowing within the passage is calculated, based on the times of flight of the first and second signals. An electrical signal is sent to the first transducer. Upon conclusion of the electrical signal, a pressure of the fluid flowing within the passage is calculated, based at least in part on time of decay of a second electrical signal generated by vibration of the first transducer.

### BACKGROUND

Utility meters measure flowrates of consumable products, including gas, water, and in some cases steam. However, meters measuring flowrates are unable to provide pressure measurements. Accordingly, improved metrology devices for gas, water, steam, etc., would be welcome by industry.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components. Moreover, the figures are intended to illustrate general concepts, and not to indicate required and/or necessary elements.

FIG. 1 is a block diagram showing an example meter having features configured to measure fluid flowrate and fluid pressure.

FIG. 2 is a block diagram showing a second example meter, characterized by piezo devices having elastic layers on both sides.

FIG. 3 is a diagram showing axial resonance within a piezo device.

FIG. 4 is a diagram showing radial resonance within a piezo device.

FIG. 5 is a diagram showing a piezo device having an elastic layer that tends to damp vibration.

FIG. 6 is a diagram showing a piezo device having two elastic layers that tend to damp vibration.

FIGS. 7A and 7B, collectively, are a flow diagram showing an example method to operate a unified system for pressure and flowrate measurement.

FIG. 8 is a flow diagram showing example operation of a processor configured to switch a signal generator between generation of a frequency at which axial vibration of a piezo device resonates and a frequency at which radial vibration of a piezo device resonates.

### DETAILED DESCRIPTION

### Overview

The disclosure describes techniques for providing a unified system for pressure and flowrate measurement of fluids. In the example of a utility company and/or utility customer environment, the fluid may include natural gas, water, steam, etc., which may be measured both for flowrate and for pressure. In an example metering device, a processor (e.g., controller, microprocessor, etc.) may access a computer-readable memory and obtain executable statements to operate the metering device. The metering device may additionally include one or more signal generators, one or more signal measurements devices, and first and second transducer devices. Each transducer may include a piezo device, an elastic layer on the piezo device, and input and output wiring.

In example operation of the flowrate functionality, input wiring of a transducer (e.g., an upstream transducer) receives a signal from a signal generator. The signal may be sent at a resonant frequency of axial vibration of the piezo devices of the two transducers. In response, the piezo device of the upstream transducer vibrates and sends an acoustic signal, which may flow through the fluid flow in a first direction (e.g., downstream). The acoustic signal vibrates a piezo device of a downstream transducer, which generates an electric current on the output wiring of the downstream transducer. A signal measurement device recognizes the signal, and the downstream time-of-flight (ToF) of the acoustic signal is measured.

To measure the upstream ToF, input wiring of the downstream transducer receives a signal from a signal generator. In response, the piezo device of the downstream transducer vibrates and sends an acoustic signal, which may flow through the fluid flow in a second direction (e.g., upstream). The acoustic signal vibrates the piezo device of the upstream transducer, which generates an electric current on the output wiring of the upstream transducer. A signal measurement device recognizes the signal, and the upstream ToF of the acoustic signal is measured. Using the upstream and the downstream ToF values, the flowrate of the fluid may be measured.

To measure fluid pressure, input wiring of one of the transducers (e.g., the upstream transducer) receives a signal from the signal generator. The signal may be sent near a resonant frequency of radial vibration of the piezo device of the transducer. Accordingly, the piezo device resonates radially at or near the resonate frequency. When the signal inducing the resonance is turned off, the vibration subsides in a manner that allows the pressure of the fluid to be determined. As the piezo device vibrates with progressively less intensity or amplitude, the output of the piezo device is an electrical signal from which the fluid pressure may be derived. In an example, the subsiding vibration of the piezo device (after the input signal is turned off) is a function of fluid pressure, and the fluid pressure may be derived from the output signal of the piezo device. In an example, higher fluid pressure causes the piezo device stop vibrating more quickly than lower fluid pressure, after the input signal (that caused the vibration) is turned off. Accordingly, a speed at which the output signal of the piezo device decays may be used to derive the fluid pressure.

Accordingly, the flowrate and the pressure of the fluid may be determined by operation of the unified system for pressure and flowrate measurement of fluids.

### Example System and Techniques

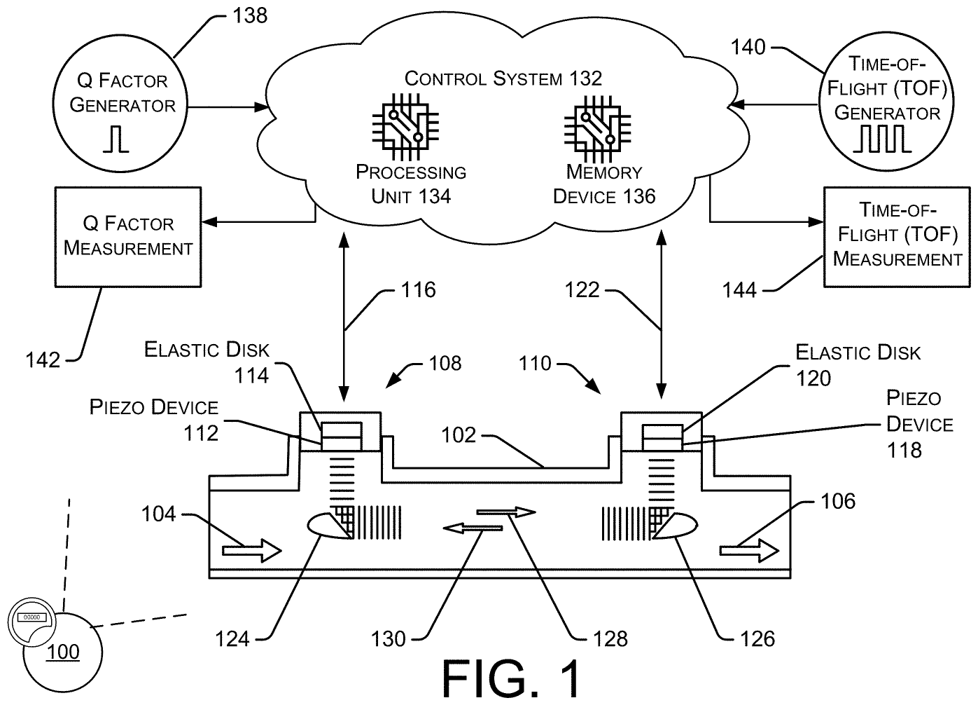

FIG. 1 shows an example meter 100 having features configured provide a unified system to measure fluid flowrate and fluid pressure. In the example shown, a pipe 102 forms a passage through which fluid flows. The fluid may be natural gas, water, steam, etc. In the example shown, fluid flows from an upstream location 104 to a downstream location 106 within the pipe 102, which may be inside an enclosure (not shown for clarity) of the meter 100. A first or upstream transducer 108 includes a piezo device 112 having an attached elastic layer 114. Additionally, wiring 116 provides input and output functionality. An input electrical signal will cause the piezo device to vibrate based on a frequency of the input electrical signal. Vibration of the device will cause a corresponding acoustic signal, since the piezo device is in contact with the fluid flowing through the pipe 102. Additionally, if the piezo device is vibrated (such as by an acoustic signal from a different piezo device) then the piezo device will generate electricity and an output signal will be present on the wiring 116.

The second transducer 110 includes a piezo device 118 and an attached elastic layer 120. Input and output wiring 122 allow the piezo device to be stimulated (by the input wiring) and allows the piezo device to be monitored (by the output wiring) for current that is generated if the piezo device is stimulated by a different device.

In the example shown, reflectors 124, 126 reflect an acoustic signal sent by one transducer device 108 to the other transducer device 110, and the reverse. Accordingly, an input signal on wiring 116 will stimulate the piezo device 112 of transducer 108. The resulting acoustic signal 128 will be reflected first by reflector 124 and then by reflector 126. The acoustic signal 128 will vibrate the piezo device 118 of transducer 110, and create a current which is output on wiring 122. The reverse is also true, in that an input signal on wiring 122 will stimulate the piezo device 118 of transducer 110. The resulting acoustic signal 130 will be reflected first by reflector 126 and then by reflector 124. The acoustic signal 130 will vibrate the piezo device 112 of transducer 108, and create a current which is output on wiring 116.

In the example implementation of FIG. 1, a control system 132 includes a processing unit 134 and memory device 136. The memory device may have software including computer- or processor-executable statements to control operation of a Q factor signal generator 138, a time-of-flight signal generator 140, a Q factor signal measurement device 142, and a time-of-flight signal measurement device 144.

In an example, responsive to a command or signal from the processor 134, the ToF signal generator 140 provides a signal that is at or near the axial resonant frequency of the piezo devices 112, 118 to thereby generate acoustic signals 128, 130, respectively. The ToF signal measurement device 144 measures the timing of the signals (i.e., the time between signal transmission and signal receipt). The processor 134 executing software obtained from the memory device 136 can process the two time-of-flight values and derive a fluid flowrate.

In a further example, responsive to a command or signal from the processor 134, the Q factor generator 138 provides a signal that is at or near the radial resonant frequency of the piezo device 112 (or piezo device 118, either could be used). The Q factor signal measurement device 138 measures the output of the piezo device 112 after the signal from the Q factor generator 138 is turned off. The processor 134 executing software obtained from the memory device 136 can examine and process the output signal (e.g., received from wiring 116) of piezo device 112, which describes aspects of the decay of the “ringing” (i.e., vibration) of the piezo device after the input signal was turned off. By examination of the resulting output signal of the transducer 108, the processor 134 can then calculate a pressure of the fluid.

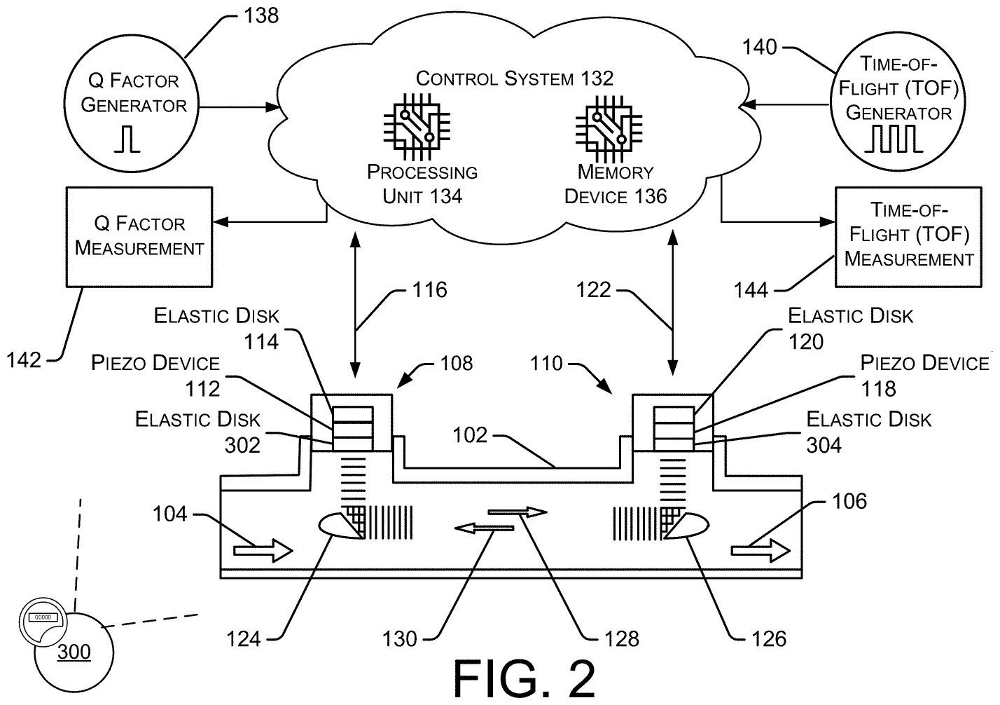

FIG. 2 shows a second example meter 200 having features configured to measure fluid flowrate and fluid pressure. The meter 200 includes an alternative design, wherein the piezo device 112 or transducer 108 has elastic disks 114, 302 on both surfaces. Similarly, the piezo device 118 or transducer 110 has elastic disks 120, 304 on both surfaces. To satisfy some design requirements, the configuration of meter 100 of FIG. 1 is preferred. In other instances, the configuration of meter 100 of FIG. 2 is preferred.

In the examples of FIGS. 1 and 2, the first and second transducers 108, 110 may be made of a piezoelectric micro-machined ultrasonic transducer (PMUT) or a capacitive micromachined ultrasonic transducer (CMUT) that is a micro-electro-mechanical (MEMS) based ultrasonic transducer. Additionally, the first and second transducers 108, 110 may be made of any piezoelectric device type or technology, as indicated by design requirements or best practices.

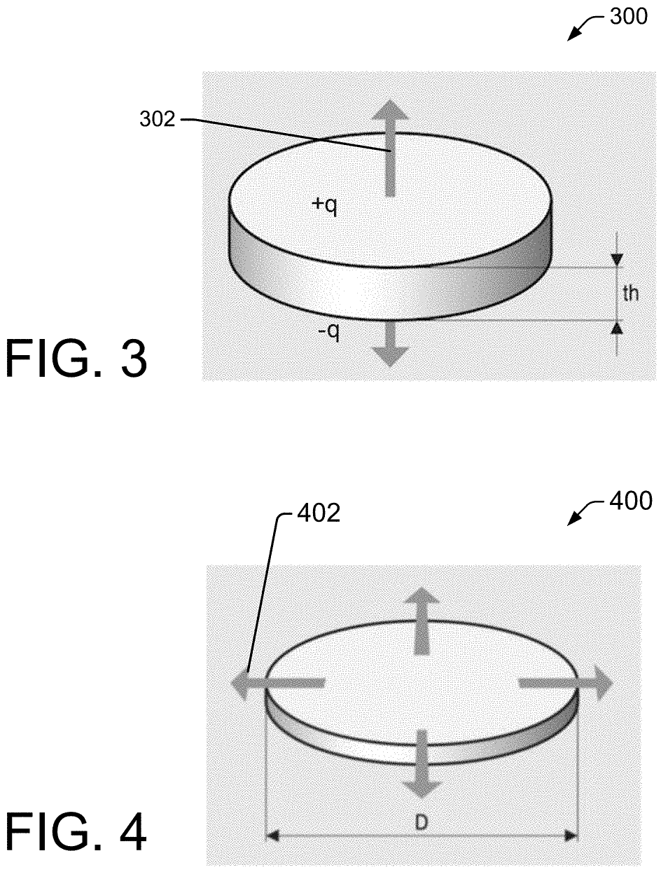

FIG. 3 shows an example piezo device 300 and the axial vibration it experiences if an input signal is applied at or near the frequency of axial resonance. In the example of FIG. 1, the input signal may be generated by the time-of-flight signal generator 140, and may be sent to the transducer 108 of the piezo device by wiring 116. In the example, the thickness (th, as shown in the diagram) varies in the axial direction, i.e., the direction of the axis 302, in response to the input electrical signal. Thus, the thickness of the piezo device varies in response to the frequency of the electrical input. If the input signal is at the axial resonant frequency, the thickness of the piezo device will vary more that it does at other frequencies. This may be advantageous if the piezo device is sending an acoustic signal to another piezo device.

FIG. 4 shows an example piezo device 400 and the radial vibration it experiences if an input signal is applied. In the example of FIG. 1, the input signal may be generated by the Q factor signal generator 138, and may be sent to the transducer 108 of the piezo device by wiring 116. In the example, the diameter (D, as shown in the diagram) varies in the radial direction, i.e., the direction of the radius 402, in response to the input electrical signal. Thus, the diameter of the piezo device varies in response to the frequency of the electrical input. If the input signal is at the radial resonant frequency, the diameter of the piezo device will vary more that it does at other frequencies. This may be advantageous when measuring the decay of those vibrations and using those measurements to calculate fluid pressure.

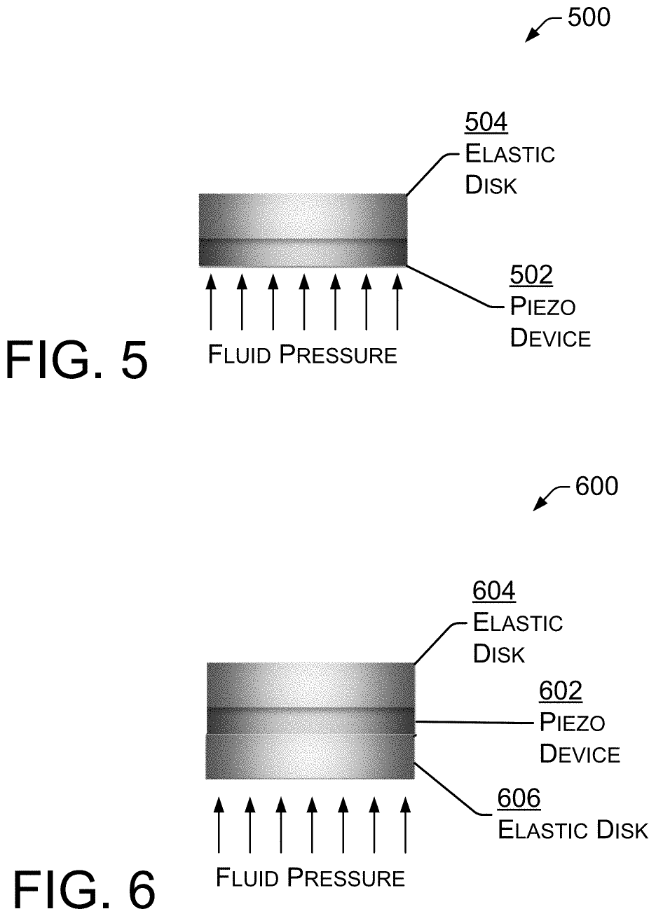

FIG. 5 shows an example of part of a transducer 500 having an elastic layer that tends to damp vibration. In the example shown, a piezo device 502 is bonded to a rubber, elastomeric or elastic disk or layer 504. In the example shown, the piezo device 502 is exposed to fluid, which applies pressure to the exposed surface of the piezo device.

FIG. 6 shows an example of part of a transducer 600 having an elastic disk on the front and back of the piezo device. The two elastic layers tend to damp radial vibration of the piezo device, and improve the sensitivity of pressure measurement. In some example implementations, the use of two elastic disks 604, 606 is more effective than the use of one elastic disk, at damping radial vibration of the piezo device 602. The damped vibration may result in greater pressure measurement sensitivity. In the example shown, an upper surface of the piezo device 602 is bonded to a rubber, elastomer and/or elastic disk or layer 604, and a lower surface of the piezo device is bonded to a second rubber, elastomer and/or elastic disk 606. In the example shown, the lower elastic disk 606 is exposed to fluid.

In both FIGS. 5 and 6, the elastic layer(s) attached to each of one or more piezo devices absorbs energy of vibration, i.e., the elastic layers damp the motion of the piezo devices.

### Example Methods

In some examples of the techniques discusses herein, the methods of operation may be performed by one or more application specific integrated circuits (ASIC) or may be performed by a general-purpose processor utilizing software defined in computer readable media. In the examples and techniques discussed herein, the memory 136 may comprise computer-readable media and may take the form of volatile memory, such as random-access memory (RAM) and/or non-volatile memory, such as read only memory (ROM) or flash RAM. Computer-readable media devices include volatile and non-volatile, removable and non-removable media implemented in any method or technology for storage of information such as computer-readable instructions, data structures, program modules, or other data for execution by one or more processors of a computing device. Examples of computer-readable media include, but are not limited to, phase change memory (PRAM), static random-access memory (SRAM), dynamic random-access memory (DRAM), other types of random access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transitory medium that can be used to store information for access by a computing device.

As defined herein, computer-readable media does not include transitory media, such as modulated data signals and carrier waves, and/or signals.

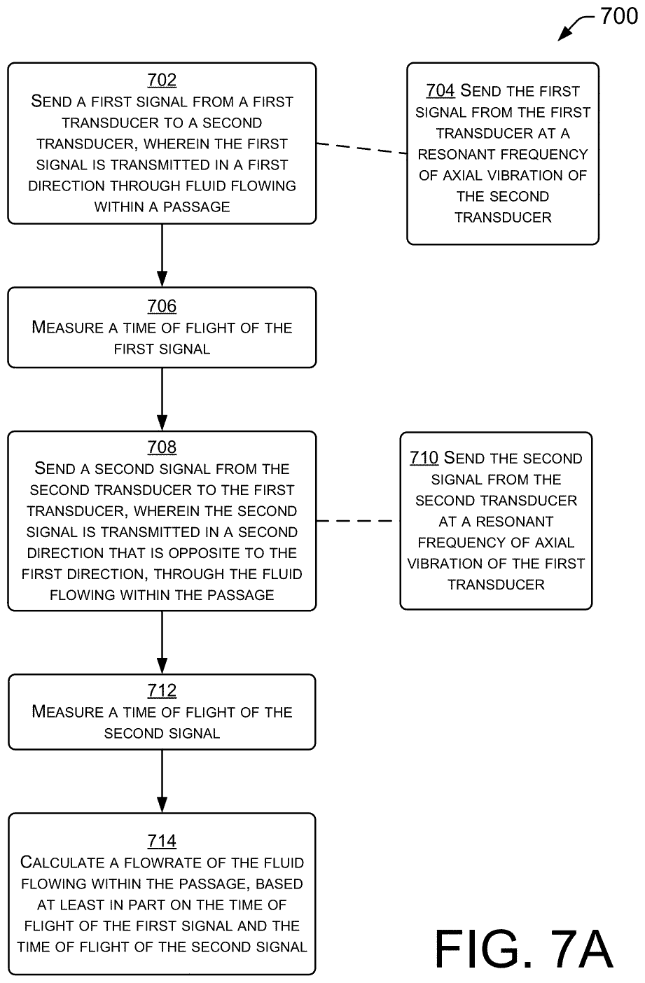

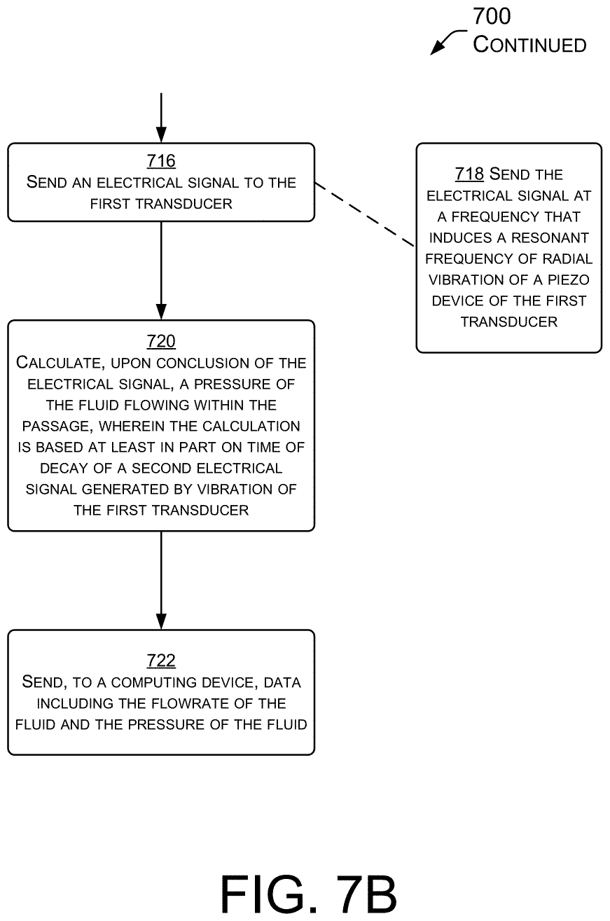

FIG. 7 shows an example method 700 to operate a unified system for pressure and flowrate measurement. Referring to FIG. 7, blocks 702-714 describe an example calculation of fluid flowrate. The example calculation involves sending a first acoustic signal in the direction of fluid flow and a second acoustic signal in the opposite direction. The difference in travel times may be used in a calculation of the flowrate.

At block 702, a first signal is sent from a first transducer to a second transducer, wherein the first signal is transmitted in a first direction through fluid flowing within a passage. In the example of FIG. 1, first signal 128 may be an acoustic signal, which is sent through the fluid from the first transducer 108 to the second transducer 110. The first acoustic signal may have been generated by a corresponding first electrical signal, sent from a signal generator (e.g., ToF signal generator 140 of FIG. 1). In an example, the ToF signal generator 140 sends a first electrical signal to the first transducer 108, which sends a first acoustic signal 128 to the second transducer 110. In the example of block 704, the first signal is sent from the first transducer by sending the first signal at a resonant frequency of axial vibration of the second transducer. Referring to FIG. 1, it is frequently the case that the resonant frequency in the axial direction of the piezo devices 112, 118 of the first and second transducers 108, 110 is the same. In many designs, the same transducer part is used in both locations. In optional designs, the axial resonant frequency does not have to be the same in the two transducers. In such designs, the signal should be sent to a transducer at, or near, the axial resonant frequency of the of the piezo device of the receiving transducer.

At block 706, time-of-flight of the first signal is measured. In the example of FIG. 1, the first acoustic signal is created by the piezo device 112, and travels through the fluid within the pipe 102. The vibrating fluid contacts the piezo device 118 of the second transducer 110. The vibrations create an output signal, voltage and/or current in the piezo device 118, which passes through the wiring 122 to the time-of-flight measurement device 144. Accordingly, the time elapsed as the signal leaves the piezo device 112 and arrives at the piezo device 118 is measured.

At block 708, a second signal is sent from the second transducer to the first transducer, wherein the second signal is transmitted in a second direction that is opposite to the first direction, through the fluid flowing within the passage. In the example of FIG. 1, first signal 130 may be an acoustic signal, which is sent through the fluid from the second transducer 110 to the first transducer 108. The second acoustic signal may have been generated by a corresponding second electrical signal, sent from a signal generator (e.g., ToF signal generator 140 of FIG. 1). In an example, the ToF signal generator 140 sends a second electrical signal to the second transducer 110, which sends a second acoustic signal 130 to the first transducer 108. In the example of block 710, and in a manner similar to block 704, the second signal, sent by the second transducer, is sent at an axial resonant frequency of the first transducer.

At block 712, a time-of-flight of the second signal is measured. In the example of FIG. 1, the second acoustic signal is created by the piezo device 118, and travels through the fluid within the pipe 102. The vibrating fluid contacts the piezo device 112 of the first transducer 108. The vibrations create an output signal, voltage and/or current in the piezo device 112, which passes through the wiring 116 to the time-of-flight measurement device 144. Accordingly, the time elapsed as the signal leaves the piezo device 118 and arrives at the piezo device 112 is measured.

At block 714, a flowrate of the fluid flowing within the passage is calculated. In the example of FIG. 1, the calculation is based at least in part on the time-of-flight of the first signal 128 and the time-of-flight of the second signal 130.

Referring to FIG. 7, blocks 716-720 describe an example calculation of fluid pressure. The example calculation involves sending an electrical signal at a frequency which causes a resonant frequency of radial vibration in a piezo device. The electrical signal is stopped, and the piezo device vibrates at progressively lower energy and/or amplitude. The rate at which the piezo device comes to rest is used to determine a fluid pressure. In an example, the greater the pressure against the piezo device after the electrical signal is stopped, the faster the vibration of the piezo device decays. In different examples, blocks 702-714 related to determining the flowrate of the fluid may be performed more frequently (or less frequently) than blocks 716-722 related to determining the pressure of the fluid.

At block 716, an electrical signal is sent to the first transducer (or the second transducer). In the example of block 718, the electrical signal is sent at a frequency that induces a resonant frequency of radial vibration in a piezo device of the first transducer.

At block 720, upon conclusion of the electrical signal, a pressure of the fluid flowing within the passage is calculated. In an example, the calculation is based at least in part on time of decay of a second electrical signal generated by vibration of the first transducer.

At block 722, data, including the flowrate of the fluid and the pressure of the fluid, is sent to a computing device, such as a central office computer, data concentrator, or other computing device.

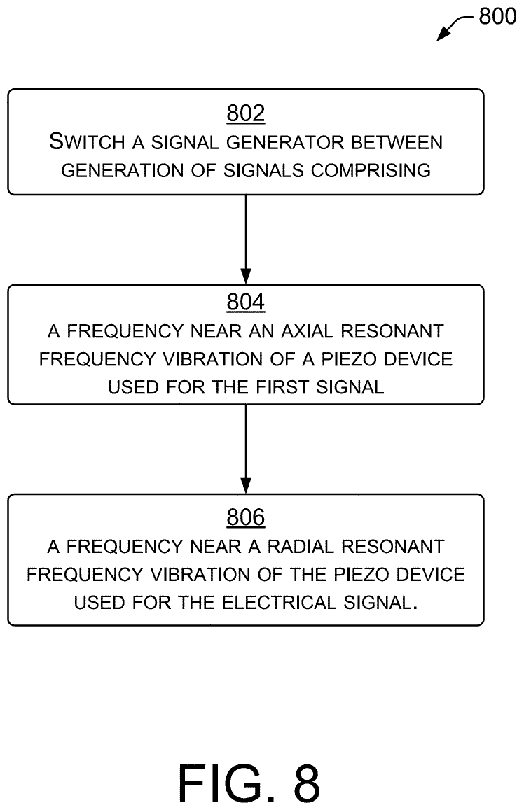

FIG. 8 shows an example method 800 of operation of a processor configured to switch a signal generator between generation of a frequency at which axial vibration of a piezo device resonates and a frequency at which radial vibration of a piezo device resonates. In an alternative design, the processor could switch between operation of two signal generators. A first signal generator may be configured to generate a signal at a frequency to cause axial vibration at a resonate frequency of a piezo device. A second signal generator may be configured to generate a signal at a frequency to cause radial vibration at a resonate frequency of a piezo device.

At block 802, a processing device switches a mode of a signal generator between two modes of operation. Alternatively, the processing device switches between two signal generators. At block 804, in a first mode of a signal generator (or using a first signal generator), a signal is generated at a frequency at or near the resonant frequency of axial vibration of a piezo device. The first mode or first signal generator may be used for fluid flowrate calculations. At block 806, in a second mode of the signal generator (or using a second signal generator), a signal is generated at or near the resonant frequency of radial vibration of the piezo device. The second mode or second signal generator may be used for fluid pressure calculations.

### Example Systems and Devices

The following examples of a unified system for pressure and flowrate measurement are expressed as number clauses. While the examples illustrate a number of possible configurations and techniques, they are not meant to be an exhaustive listing of the systems, methods, metering devices, flowrate and/or pressure measurement devices and methods of their operation as described herein.

1. A method, comprising: sending a first signal from a first transducer to a second transducer, wherein the first signal is transmitted in a first direction through fluid flowing within a passage; measuring a time-of-flight of the first signal; sending a second signal from the second transducer to the first transducer, wherein the second signal is transmitted in a second direction that is opposite to the first direction, through the fluid flowing within the passage; measuring a time-of-flight of the second signal; calculating a flowrate of the fluid flowing within the passage, based at least in part on the time-of-flight of the first signal and the time-of-flight of the second signal; sending an electrical signal to the first transducer; calculating, upon conclusion of the electrical signal, a pressure of the fluid flowing within the passage, wherein the calculation is based at least in part on time of decay of a second electrical signal generated by vibration of the first transducer; and sending, to a computing device, data comprising the flowrate of the fluid and the pressure of the fluid.

2. The method of clause 1, additionally comprising: absorbing energy of vibration of a first piezo device of the first transducer with a first elastic layer attached to the first piezo device; and absorbing energy of vibration of a second piezo device of the second transducer with a second elastic layer attached to the second piezo device.

3. The method of clause 1 or any preceding clause, wherein: sending the first signal from the first transducer comprises sending the first signal at a resonant frequency of axial vibration of the second transducer; and sending the second signal from the second transducer comprises sending the second signal at a resonant frequency of axial vibration of the first transducer; wherein the first signal and the second signal are approximately the same frequency.

4. The method of clause 1 or any preceding clause, wherein sending the electrical signal to the first transducer comprises: sending the electrical signal at a frequency that induces vibration at a resonant frequency of radial vibration of a piezo device of the first transducer.

5. The method of clause 1 or any preceding clause, wherein: the first transducer comprises a piezoelectric micro-machined ultrasonic transducer (PMUT) or a capacitive micromachined ultrasonic transducer (CMUT) that is a micro-electro-mechanical (MEMS) based ultrasonic transducer; and the second transducer comprises a PMUT or a CMUT that is a MEMS-based ultrasonic transducer.

6. The method of clause 1 or any preceding clause, wherein sending the first signal and the electrical signal comprise: switching a signal generator between generation of signals comprising: a frequency near an axial resonant frequency vibration of a piezo device used for the first signal; and a frequency near a radial resonant frequency vibration of the piezo device used for the electrical signal.

7. The method of clause 1 or any preceding clause, additionally comprising: generating the first signal using a first signal generator at a frequency near a resonant frequency of axial vibration of a piezo device; and generating the electrical signal using a second signal generator at a frequency near a resonant frequency of radial vibration of the piezo device.

8. The method of clause 1 or any preceding clause, additionally comprising: determining the flowrate of the fluid is performed more frequently than determining the pressure of the fluid.

9. The method of clause 1 or any preceding clause, additionally comprising: providing a signal from a processor that switches a signal generator between generation of a frequency near a resonance of axial piezo vibration and a frequency near a resonance of radial piezo vibration.

10. The method of clause 1 or any preceding clause, additionally comprising: providing a signal from a processor that switches from operation of a first signal generator generating a signal at a frequency near a resonance of axial piezo vibration, and a second signal generator generating a signal at a frequency near a resonance of radial piezo vibration.

11. The method of clause 1 or any preceding clause, wherein: the first signal comprises an acoustic signal near a resonant frequency of axial piezo vibration; and the electrical signal stimulates a piezo device of the first transducer at a frequency near a resonant frequency of radial piezo vibration.

12. A fluid meter, comprising: a processor; a signal generator; a signal receiver; a first transducer comprising a first piezo device having a first elastic covering, and configured to receive an input signal from the signal generator and configured to send an output signal to the signal receiver; a second transducer comprising a second piezo device having a second elastic covering, and configured to receive an input signal from the signal generator and configured to send an output signal to the signal receiver; a pipe, wherein the first transducer and the second transducer are mounted within the pipe, and wherein the first transducer and the second transducer are within a range to exchange acoustic signals; and one or more computer-readable media storing computer-executable instructions that, when executed by the processor, operate the signal generator to generate frequencies comprising: a first frequency to induce resonant vibration in an axial direction the first piezo device and the second piezo device; and a second frequency to induce resonant vibration in a radial direction of the first piezo device.

13. The fluid meter of clause 12, wherein the one or more computer-readable media additionally comprise computer-executable instructions that, when executed by the processor, perform acts comprising: sending a first signal from a first transducer to a second transducer, wherein the first signal is transmitted in a first direction through fluid flowing within a passage; measuring a time-of-flight of the first signal; sending a second signal from the second transducer to the first transducer, wherein the second signal is transmitted in a second direction that is opposite to the first direction, through the fluid flowing within the passage; measuring a time-of-flight of the second signal; calculating a flowrate of the fluid flowing within the passage, based at least in part on the time-of-flight of the first signal and the time-of-flight of the second signal; sending an electrical signal to the first transducer; calculating, upon conclusion of the electrical signal, a pressure of the fluid flowing within the passage, wherein the calculation is based at least in part on decay over time of a second electrical signal generated by vibration of the first transducer; and sending, to a computing device, data comprising the flowrate of the fluid and the pressure of the fluid.

14. The fluid meter of clause 13 or any preceding clause, wherein calculating the pressure of the fluid flowing within the passage comprises: receiving, at the signal receiver, the second electrical signal; and calculating the pressure of the fluid according to calculations performed by the processor.

15. The fluid meter of clause 13 or any preceding clause, wherein the acts additionally comprise: switching, by operation of the processor, the signal generator between generation of signals comprising: a frequency to induce resonant vibration in an axial direction of the first piezo device and the second piezo device in an alternating manner; and a frequency to induce resonant vibration in a radial direction of the first piezo device.

16. The fluid meter of clause 13 or any preceding clause, wherein the signal generator is a first signal generator and is configured to generate a signal at a frequency to induce resonant vibration in an axial direction of the first piezo device and the second piezo device, and wherein the fluid meter additionally comprises: a second signal generator configured to generate a signal at a frequency to induce resonant vibration in a radial direction of the first piezo device.

17. A device for measuring fluid pressure and fluid flow measurement, comprising: a first transducer comprising a first piezo device having a first elastic covering; a second transducer comprising a second piezo device having a second elastic covering; and one or more signal generators to generate signals comprising: a frequency to induce resonant vibration in an axial direction of the first piezo device and the second piezo device; and a frequency to induce resonant vibration in a radial direction of the first piezo device; one or more processors to calculate data comprising: a fluid flowrate value using time-of-flight information for acoustic signals sent between the first transducer and the second transducer; and a fluid pressure value using information obtained from the first piezo device as radial vibrations of that device decay after stimulation.

18. The device for fluid pressure and fluid flow measurement of clause 17, additionally comprising: one or more computer-readable media storing computer-executable instructions that, when executed by the one or more processors, perform acts comprising: sending a first signal from a first transducer to a second transducer, wherein the first signal is transmitted in a first direction through fluid flowing within a passage; measuring a time-of-flight of the first signal; sending a second signal from the second transducer to the first transducer, wherein the second signal is transmitted in a second direction that is opposite to the first direction, through the fluid flowing within the passage; measuring a time-of-flight of the second signal; calculating a flowrate of the fluid flowing within the passage, based at least in part on the time-of-flight of the first signal and the time-of-flight of the second signal; sending an electrical signal to the first transducer; calculating, upon conclusion of the electrical signal, a pressure of the fluid flowing within the passage, wherein the calculation is based at least in part on decay over time of a second electrical signal generated by vibration of the first transducer; and sending, to a computing device, data comprising the flowrate of the fluid and the pressure of the fluid.

19. The device for fluid pressure and fluid flow measurement of clause 18, wherein one or more signal generators comprises: a single signal generator configured to be switchable from the frequency to induce resonant vibration in an axial direction of the first and second piezo devices and the frequency to induce resonant vibration in a radial direction of the first piezo device.

20. The device for fluid pressure and fluid flow measurement of clause 18 or any preceding clause, wherein one or more signal generators comprises: a first signal generator configured to generate the frequency to induce resonant vibration in the axial direction of the first or second piezo device; and a second signal generator configured to generate the frequency to induce resonant vibration in a radial direction of the first or second piezo device.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method, comprising:
sending a first signal from a first transducer to a second transducer, wherein the first signal is transmitted in a first direction through fluid flowing within a passage;
measuring a time-of-flight of the first signal;
sending a second signal from the second transducer to the first transducer, wherein the second signal is transmitted in a second direction that is opposite to the first direction, through the fluid flowing within the passage;
measuring a time-of-flight of the second signal;
calculating a flowrate of the fluid flowing within the passage, based at least in part on the time-of-flight of the first signal and the time-of-flight of the second signal;
sending an electrical signal to the first transducer;
calculating, upon conclusion of the electrical signal, a pressure of the fluid flowing within the passage, wherein the calculation is based at least in part on time of decay of a second electrical signal generated by vibration of the first transducer; and
sending, to a computing device, data comprising the flowrate of the fluid and the pressure of the fluid.

2. The method of claim 1, additionally comprising:
absorbing energy of vibration of a first piezo device of the first transducer with a first elastic layer attached to the first piezo device; and
absorbing energy of vibration of a second piezo device of the second transducer with a second elastic layer attached to the second piezo device.

3. The method of claim 1, wherein:
sending the first signal from the first transducer comprises sending the first signal at a resonant frequency of axial vibration of the second transducer; and
sending the second signal from the second transducer comprises sending the second signal at a resonant frequency of axial vibration of the first transducer;
wherein the first signal and the second signal are approximately the same frequency.

4. The method of claim 1, wherein sending the electrical signal to the first transducer comprises:
sending the electrical signal at a frequency that induces vibration at a resonant frequency of radial vibration of a piezo device of the first transducer.

5. The method of claim 1, wherein:
the first transducer comprises a piezoelectric micro-machined ultrasonic transducer (PMUT) or a capacitive micromachined ultrasonic transducer (CMUT) that is a micro-electro-mechanical (MEMS) based ultrasonic transducer; and
the second transducer comprises a PMUT or a CMUT that is a MEMS-based ultrasonic transducer.

6. The method of claim 1, wherein sending the first signal and the electrical signal comprise:
switching a signal generator between generation of signals comprising:
a frequency near an axial resonant frequency vibration of a piezo device used for the first signal; and
a frequency near a radial resonant frequency vibration of the piezo device used for the electrical signal.

7. The method of claim 1, additionally comprising:
generating the first signal using a first signal generator at a frequency near a resonant frequency of axial vibration of a piezo device; and
generating the electrical signal using a second signal generator at a frequency near a resonant frequency of radial vibration of the piezo device.

8. The method of claim 1, additionally comprising:
determining the flowrate of the fluid is performed more frequently than determining the pressure of the fluid.

9. The method of claim 1, additionally comprising:
providing a signal from a processor that switches a signal generator between generation of a frequency near a resonance of axial piezo vibration and a frequency near a resonance of radial piezo vibration.

10. The method of claim 1, additionally comprising:
providing a signal from a processor that switches from operation of a first signal generator generating a signal at a frequency near a resonance of axial piezo vibration, and a second signal generator generating a signal at a frequency near a resonance of radial piezo vibration.

11. The method of claim 1, wherein:
the first signal comprises an acoustic signal near a resonant frequency of axial piezo vibration; and
the electrical signal stimulates a piezo device of the first transducer at a frequency near a resonant frequency of radial piezo vibration.

12. A fluid meter, comprising:
a processor;
a signal generator;
a signal receiver;
a first transducer comprising a first piezo device having a first elastic covering, and configured to receive an input signal from the signal generator and configured to send an output signal to the signal receiver;
a second transducer comprising a second piezo device having a second elastic covering, and configured to receive an input signal from the signal generator and configured to send an output signal to the signal receiver;
a pipe, wherein the first transducer and the second transducer are mounted within the pipe, and wherein the first transducer and the second transducer are within a range to exchange acoustic signals; and
one or more computer-readable media storing computer-executable instructions that, when executed by the processor, operate the signal generator to generate frequencies comprising:
a first frequency to induce resonant vibration in an axial direction the first piezo device and the second piezo device; and
a second frequency to induce resonant vibration in a radial direction of the first piezo device.

13. The fluid meter of claim 12, wherein the one or more computer-readable media additionally comprise computer-executable instructions that, when executed by the processor, perform acts comprising:
sending a first signal from a first transducer to a second transducer, wherein the first signal is transmitted in a first direction through fluid flowing within a passage;
measuring a time-of-flight of the first signal;
sending a second signal from the second transducer to the first transducer, wherein the second signal is transmitted in a second direction that is opposite to the first direction, through the fluid flowing within the passage;
measuring a time-of-flight of the second signal;
calculating a flowrate of the fluid flowing within the passage, based at least in part on the time-of-flight of the first signal and the time-of-flight of the second signal;
sending an electrical signal to the first transducer;
calculating, upon conclusion of the electrical signal, a pressure of the fluid flowing within the passage, wherein the calculation is based at least in part on decay over time of a second electrical signal generated by vibration of the first transducer; and
sending, to a computing device, data comprising the flowrate of the fluid and the pressure of the fluid.

14. The fluid meter of claim 13, wherein calculating the pressure of the fluid flowing within the passage comprises:
receiving, at the signal receiver, the second electrical signal; and
calculating the pressure of the fluid according to calculations performed by the processor.

15. The fluid meter of claim 13, wherein the acts additionally comprise:
switching, by operation of the processor, the signal generator between generation of signals comprising:
a frequency to induce resonant vibration in an axial direction of the first piezo device and the second piezo device in an alternating manner; and
a frequency to induce resonant vibration in a radial direction of the first piezo device.

16. The fluid meter of claim 13, wherein the signal generator is a first signal generator and is configured to generate a signal at a frequency to induce resonant vibration in an axial direction of the first piezo device and the second piezo device, and wherein the fluid meter additionally comprises:
a second signal generator configured to generate a signal at a frequency to induce resonant vibration in a radial direction of the first piezo device.

17. A device for measuring fluid pressure and fluid flow measurement, comprising:
a first transducer comprising a first piezo device having a first elastic covering;
a second transducer comprising a second piezo device having a second elastic covering; and
one or more signal generators to generate signals comprising:
a frequency to induce resonant vibration in an axial direction of the first piezo device and the second piezo device; and
a frequency to induce resonant vibration in a radial direction of the first piezo device;
one or more processors to calculate data comprising:
a fluid flowrate value using time-of-flight information for acoustic signals sent between the first transducer and the second transducer; and
a fluid pressure value using information obtained from the first piezo device as radial vibrations of that device decay after stimulation.

18. The device for fluid pressure and fluid flow measurement of claim 17, additionally comprising:
one or more computer-readable media storing computer-executable instructions that, when executed by the one or more processors, perform acts comprising:
sending a first signal from a first transducer to a second transducer, wherein the first signal is transmitted in a first direction through fluid flowing within a passage;
measuring a time-of-flight of the first signal;
sending a second signal from the second transducer to the first transducer, wherein the second signal is transmitted in a second direction that is opposite to the first direction, through the fluid flowing within the passage;
measuring a time-of-flight of the second signal;
calculating a flowrate of the fluid flowing within the passage, based at least in part on the time-of-flight of the first signal and the time-of-flight of the second signal;
sending an electrical signal to the first transducer;
calculating, upon conclusion of the electrical signal, a pressure of the fluid flowing within the passage, wherein the calculation is based at least in part on decay over time of a second electrical signal generated by vibration of the first transducer; and
sending, to a computing device, data comprising the flowrate of the fluid and the pressure of the fluid.

19. The device for fluid pressure and fluid flow measurement of claim 18, wherein one or more signal generators comprises:
a single signal generator configured to be switchable from the frequency to induce resonant vibration in an axial direction of the first and second piezo devices and the frequency to induce resonant vibration in a radial direction of the first piezo device.

20. The device for fluid pressure and fluid flow measurement of claim 18, wherein one or more signal generators comprises:
a first signal generator configured to generate the frequency to induce resonant vibration in the axial direction of the first or second piezo device; and
a second signal generator configured to generate the frequency to induce resonant vibration in a radial direction of the first or second piezo device.
